(19) United States
(12) Patent Application Publication
(10) Pub. No.: US 2026/0362109 A1
(43) Pub. Date: Nov. 12, 2026

(54) Alarm device adapted to transmit an alert message in the presence of frequency jamming

(71) Applicant: TELECOM DESIGN, CANEJAN (FR)

(72) Inventors: Didier FILHOL, Le Lavandou (FR); Stanislas MARLY, Mérignac (FR)

(21) Appl. No.: 19/515,122

(22) PCT Filed: Sep. 4, 2024
(86) PCT No.: PCT/EP2024/074639

§ 371 Date: Feb. 27, 2026

(30) Foreign Application Priority Data
Sep. 8, 2023 (EP) 23306493.0

(51) Int. Cl. H04W 4/90; H04M 11/04; H04W 56/00; H04W 74/0836; H04W 76/30

(52) U.S. Cl. CPC H04W 4/90; H04M 11/04; H04W 56/0055; H04W 74/0836; H04W 76/30

(57) ABSTRACT

A method for the transmission of an alert message by an alarm device, to a cellular network, in the presence of frequency jamming. The method includes the following steps:
at a first time, in the absence of jamming: obtaining preconfigured radio resources indented to be used for the transmission of the alert message at least one future time (t_{E1}),
at least one calibration time between the first time and said at least one future time: calibrating a clock of the alarm device to correct any drift of said clock relative to a clock of the cellular network,
when an intrusion is detected by the alarm device: checking whether jamming is present,
if jamming is present: transmitting the alert message at said at least a future time using the preconfigured radio resources.

### CROSS-REFERENCE TO RELATED APPLICATION(S)

This application is a National Stage of International Application No. PCT/EP2024/074639, having an International Filing Date of Sep. 4, 2024, which designated the United States of America, and which International Application was published under PCT Article 21(2) as WO Publication No. 2025/051757 which claims priority under 35 USC § 119(e) of French Patent Application No. 23306493.0, filed on Sep. 8, 2023, the disclosures of which are hereby incorporated by reference in their entireties.

### BACKGROUND

### 1. Field

The present disclosure belongs to the field of alarm devices (intrusion detection devices in a zone to be protected). More particularly, the present disclosure relates to an alarm device adapted to transmit an alert message to a cellular network in the presence of jamming of the frequencies of the cellular network.

### 2. Prior Art

Numerous alarm devices are proposed on the market for protecting a building against intrusion. These devices are designed to detect and signal an unauthorized intrusion in a zone to be protected (enclosure, house, apartment, room of a building, etc.). Their purpose is to contribute to the monitoring and protection of buildings, property and people.

Alarm devices are generally equipped with infrared or radar sensors making it possible to detect an intrusion into the zone to be protected. In response to intrusion detection, the device may trigger deterrents (for example, a siren or a fumigant generator) and transmit an alert message to a remote monitoring server.

The alert message is generally transmitted via a wireless cellular communication network, such as an LTE (Long Term Evolution network, which is the fourth-generation, or 4G, standard, specified by the 3GPP consortium) or a 5G-NR network (5G-New Radio network, which is the fifth-generation, or 5G, 3GPP standard).

To prevent the alarm device from transmitting the alert message, a person with malicious intentions may use a frequency jammer. A jammer is a radio transmitter designed to jam, disturb or block radiocommunication signals. In general, it acts by transmitting a noise signal at a higher radio power level than wanted signals, on one or more frequency bands. Wanted signals are then no longer detected by the receivers.

To overcome this problem, it is known to transmit the alert message via a particular wireless communication network which uses radio transmission techniques which have a low sensitivity to frequency jamming. In particular, it may consists of an LPWAN (Low Power Wide Area Network) type network, which uses the ultra-narrow band (UNB) communication technique. Patent EP 3 477 611 B1 gives an example of an alarm device comprising a radiocommunication module configured to send an alert message to an LPWAN network in monodirectional mode when radio jamming is detected.

However, such an LPWAN network implementing jamming-resistant radio technology is not always available. In such a case, it is necessary to use a cellular network to transmit the alert message. Unlike LPWAN networks with a monodirectional link, cellular networks are bidirectional, which means that a terminal and a base station in the cellular network must be synchronized in time and frequency to communicate. Also, the terminal must receive a message from the base station on a downlink to obtain radio resources to be used on an uplink to transmit a message. However, in the event of frequency jamming at the terminal, the latter will not be able to receive the resource allocation message for the transmission of the alert message.

### SUMMARY

The objective of the present disclosure is to remedy all or some of the drawbacks of the prior art, especially those disclosed above.

To this end, and according to a first aspect, a method is proposed by the present disclosure for the transmission of an alert message by an alarm device in the presence of jamming of frequency bands of a downlink of the cellular network. The method comprises the following steps:
at a first time, in the absence of jamming: obtaining, from a message transmitted by the cellular network and received by the alarm device, preconfigured radio resources capable of being used for the transmission of the alert message at least one future time,
at least one calibration time between the first time and said at least one future time: calibrating a clock of the alarm device to correct any drift of said clock relative to a clock of the cellular network,
when an intrusion is detected by the alarm device: checking whether jamming is present,
if jamming is present: transmitting the alert message to said least one future time using the preconfigured radio resources.

In particular implementations, the present disclosure may further comprise one or more of the following features, taken individually or according to all technically possible combinations.

In particular implementations, the cellular network is an LTE or 5G-NR network supporting the “PUR” procedure defined by the 3GPP R16 specification; the preconfigured radio resources are defined by a “PUR” configuration received by the alarm device in a connection release message, “RRC Release”, transmitted by a station of the cellular network; the alert message is transmitted by the alarm device on an uplink shared channel, “(N)PUSCH”, independently of a condition relating to the power level received from a reference signal, “(N)RSRP”, or to a timing advance, “TA”, for said station.

In particular implementations, the cellular network is a 5G-NR network supporting the “CG-SDT Type 1” procedure defined by the 3GPP R17 specification; the preconfigured radio resources are defined by a “CG-SDT Type 1” configuration received by the alarm device in a connection release message, “RRC Release”, transmitted by a station of the cellular network; the alert message is emitted by the alarm device on an uplink shared channel, “(N)PUSCH”, regardless of a condition relating to the power level received from a reference signal, “(N)RSRP”, or to a timing advance, “TA”, for said station.

In particular implementations, the cellular network is a 5G-NR network supporting the two-step short packet transmission procedure on a random access channel, “2-step RA-SDT”, defined by the 3GPP R17 specification; the preconfigured radio resources are defined by a “PRACH” configuration received by the alarm device in a system information message, “SIB1”, transmitted by a station of the cellular network; the alert message is transmitted by the alarm device on a random access channel, “(N)PRACH”, independently of a condition relating to the power level received from a reference signal, “(N)RSRP”, for said station.

In particular implementations, the preconfigured radio resources define several transmission opportunities at several future times, and the alert message is repeatedly transmitted at several of said future times.

In particular implementations, the calibration step comprises:
computing a clock time corresponding to a number of clock ticks performed by the clock of the alarm device between a reception time of a first synchronization frame, and a reception time of a second synchronization frame,
computing an offset corresponding to a time difference between the clock time and a reference time corresponding to a theoretical time difference separating the first and second synchronization frames,
updating the clock of the alarm device according to the offset thus computed.

In particular implementations, the clock of the alarm device is a high-precision and low-frequency clock, the alarm device further comprises an additional low-precision and high-frequency clock, and the calibration step comprises:
at each clock tick of the low-frequency clock, resetting a clock tick counter of the high-frequency clock,
determining a number of clock ticks of the low-frequency clock between a reception time of a first synchronization frame, and a reception time of a second synchronization frame,
computing a clock time according to the number of clock ticks of the low-frequency clock, and according to the number of clock ticks indicated by the clock tick counter of the high-frequency clock respectively at the reception time of the first synchronization frame and at the reception time of the second synchronization frame,
computing an offset corresponding to a difference between the clock time thus computed and a reference time corresponding to a theoretical time difference separating the first and second synchronization frames,
updating the low-frequency clock according to the offset thus computed.

In particular implementations, said at least one calibration time is defined by the alarm device according to a maximum drift duration, said maximum drift duration being predefined according to the duration of a cyclic prefix present in a frame of the cellular network and according to a precision level of the clock of the alarm device.

In particular implementations, the step of checking whether jamming is present comprises:
partitioning at least one frequency band of the downlink of the cellular network into several frequency sub-bands,
measuring, for each frequency sub-band, of a received radio power level,
evaluating a jamming detection criterion according to the measurements obtained.

According to a second aspect, the present disclosure relates to an alarm device adapted to transmit an alert message to a cellular network in the presence of jamming of frequency bands of a downlink of the cellular network. The alarm device comprises a wireless communication module adapted to communicate with the cellular network, a clock, a jamming detection module, and an intrusion detection module. The alarm device is configured to:
at a first time, in the absence of jamming: obtain preconfigured radio resources, from a message transmitted by the cellular network and received by the communication module, said preconfigured radio resources being capable of being used by the communication to transmit the alert message at least one future time,
at least one calibration time between the first time and said at least one future time: calibrate the clock to correct any drift of said clock relative to a clock of the cellular network,
when an intrusion is detected by the intrusion detection module: check whether jamming is present using the jamming detection module,
if jamming is present: transmit the alert message to said least one future time using the preconfigured radio resources.

In particular embodiments, the present disclosure may further comprise one or more of the following features, taken alone or according to any technically possible combinations.

In particular implementations, the communication module is configured to receive the preconfigured radio resources in a “PUR” configuration included in a connection release message, “RRC Release”, transmitted by a station of the cellular network. The communication module is configured to transmit the alert message on an uplink shared channel, “(N)PUSCH”, independently of a condition relative to the power level received from a reference signal, “(N)RSRP”, or to a timing advance, “TA”, for said station.

In particular implementations, the communication module is configured to receive the preconfigured radio resources in a “CG-SDT Type 1” configuration included in a connection release message, “RRC Release”, transmitted by a station of the cellular network. The communication module is configured to transmit the alert message on an uplink shared channel, “(N)PUSCH”, independently of a condition relative to the power level received from a reference signal, “(N)RSRP”, or to a timing advance, “TA”, for said station.

In particular implementations, the communication module is configured to receive the preconfigured radio resources in a “PRACH” configuration included in a system information message, “SIB1”, transmitted by a station of the cellular network. The communication module is configured to transmit the alert message on a random access channel, “(N)PRACH”, independently of a condition relative to the power level received from a reference signal, “(N)RSRP”, for said station.

In particular implementations, the alarm device is configured to:
compute a clock time corresponding to a number of clock ticks performed by the clock between a reception time of a first synchronization frame, and a reception time of a second synchronization frame,
compute an offset corresponding to a difference between the clock time and a reference time corresponding to a theoretical time difference separating the first and second synchronization frames,
update the clock according to the offset thus computed.

In particular implementations, the clock of the alarm device is a high-precision and low-frequency clock, the alarm device further comprises an additional low-precision and high-frequency clock, and the alarm device is configured to:
at each clock tick of the low-frequency clock, reset a clock tick counter of the high-frequency clock,
determine a number of clock ticks of the low-frequency clock between a reception time of a first synchronization frame, and a reception time of a second synchronization frame,
compute a clock time according to the number of clock ticks of the low-frequency clock, and according to the number of clock ticks indicated by the clock tick counter of the high-frequency clock respectively at the reception time of the first synchronization frame and at the reception time of the second synchronization frame,
compute an offset corresponding to a difference between the clock time and a reference time corresponding to a theoretical time difference separating the first and second synchronization frames,
updating the low-frequency clock according to the offset thus computed.

### BRIEF DESCRIPTION OF DRAWINGS

The present disclosure will be better understood upon reading the following description, given by way of non-limiting example, and made by referring to FIGS. 1 to 11, which represent:

FIG. 1 a schematic representation of the main steps of an exemplary implementation of a method according to the present disclosure for transmitting an alert message in the presence of jamming,

FIG. 2 another representation of the main steps of an exemplary implementation of the method according to the present disclosure,

FIG. 3 a timing diagram representing several transmission opportunities and several calibration procedures of the clock of the alarm device,

FIG. 4 a schematic representation of an alarm device transmitting an alert message to a remote monitoring server via a cellular network,

FIG. 5 a sequence diagram illustrating a first exemplary of implementation of the steps of obtaining preconfigured radio resources, and transmitting an alert message using these resources,

FIG. 6 a sequence diagram illustrating a second exemplary implementation of the steps of obtaining preconfigured radio resources, and transmitting an alert message using these resources,

FIG. 7 a schematic representation of a first embodiment of an alarm device according to the present disclosure,

FIG. 8 a schematic representation of a second embodiment of an alarm device according to the present disclosure,

FIG. 9 a schematic representation of the calibration of the clock of the alarm device according to the first embodiment illustrated in FIG. 7,

FIG. 10 a schematic representation of the calibration of the clock of the alarm device according to the second embodiment illustrated in FIG. 8,

FIG. 11 a sequence diagram illustrating a conventional four-step random access procedure.

In these figures, identical references from one figure to another refer to identical or similar elements. For clarity, the elements shown are not necessarily plotted to the same scale, unless stated otherwise.

### DETAILED DESCRIPTION

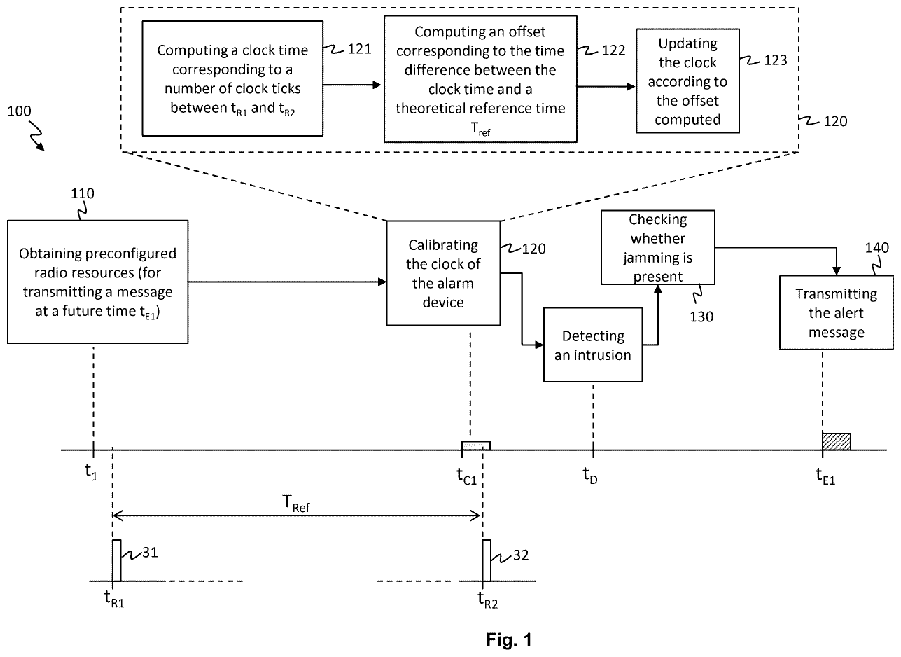

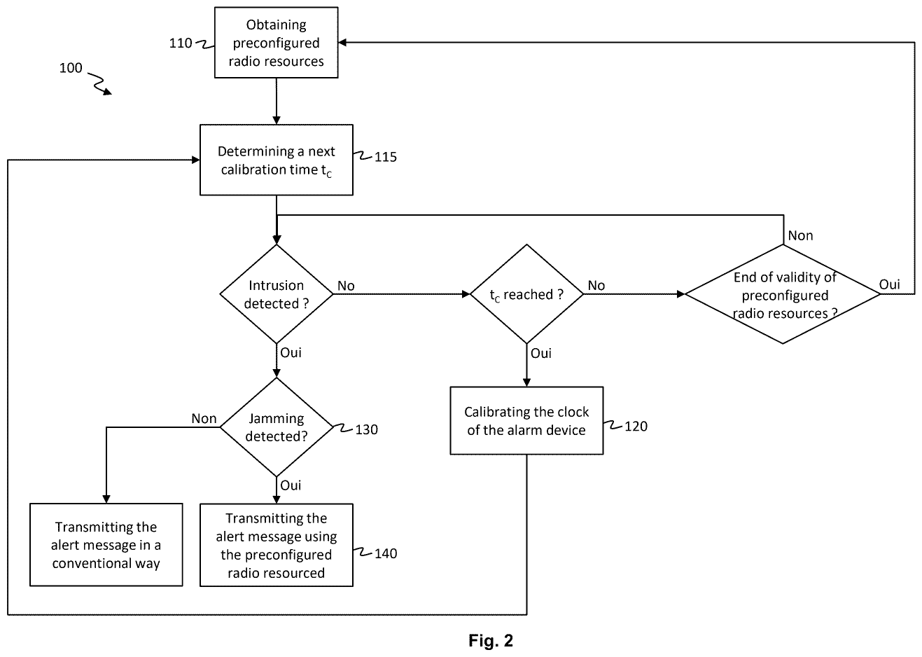

FIGS. 1 and 2 schematically represent the main steps of an exemplary implementation of a method 100 according to the present disclosure to allow an alarm device to transmit an alert message even in the presence of frequency jamming.

FIG. 4 represents the transmission of an alert message by an alarm device 10 to a remote monitoring server 40 via a cellular network 20. The alert message is transmitted on an uplink 23 of the alarm device 10 to the cellular network 20.

The alarm device 10 is for example designed to detect and signal an unauthorized intrusion in a zone to be protected. This may consist of an outdoor zone (enclosure, courtyard, garden, etc.) or an indoor zone (house, apartment, room of a building, etc.). The remote monitoring server 40 is for example implemented by a remote monitoring operator to trigger actions in response to the alert message (establishing communication with a person responsible for the protected zone wherein the intrusion took place, sending a security guard to the zone, etc.). Communication between the alarm device 10 and the remote monitoring server 40 is established via the cellular network 20. This cellular network 20 is a wireless communication network which acts as a radio access network (RAN) to a core network 30 (e.g. Internet) to which the remote monitoring server 40 is connected. The cellular network 20 corresponds for example to an LTE network, a 5G-NR network, or a sixth-generation (6G) 3GPP network. This can be a cellular network for connected objects (IoT for “Internet of Things”), such as, for example, an LTE-M (or LTE-CAT-M for “LTE category M”) or NB-IoT (acronym of “Narrow-Band IoT”). LTE-M and NB-IoT are variants of LTE and 5G-NR networks for IoT. As schematically illustrated in FIG. 4, the cellular network 20 comprises base stations 21 connected to infrastructures 22 serving as gateways to the core network 30.

The alarm device 10 is configured to implement the method 100 according to the present disclosure. In particular, the alarm device 10 is configured to be able to transmit the alert message to the cellular network 20 even in the presence of jamming of the frequency bands of the downlink 24 of the cellular network 20. In FIG. 4, frequency jamming of the downlink 24 is represented by X. This means that in the presence of jamming, the alarm device 10 is no longer capable of receiving a message from the cellular network 20. Frequency jamming is for example implemented by a person with malicious intentions to prevent the alarm device from transmitting the alert message. Jamming consists, for example, in transmitting a noise signal at a higher radio power level than wanted signals, on one or more frequency bands of the downlink 24 of the cellular network 20. Wanted signals can then no longer be detected by the receivers in proximity to the jammer.

It should be noted that jamming mainly affects the downlink 24, and that it does not significantly impact the uplink 23. In other words, jamming prevents the alarm device 10 from receiving a message from the cellular network 20, but it does not prevent the cellular network 20 from receiving a message transmitted by the alarm device 10. However, in order to be able to transmit a message to the cellular network 20, the alarm device 10 must be able to be synchronized with the cellular network 20 and receive radio resources allocated by the cellular network 20. Jamming of the downlink 23 therefore generally also makes it possible to prevent the alarm device 10 from transmitting a message. The present disclosure described in the present application provides a solution to allow the alarm device 10 to transmit an alert message to the cellular network 20 even in the presence of jamming of the frequency bands of the downlink 24 of the cellular network 20.

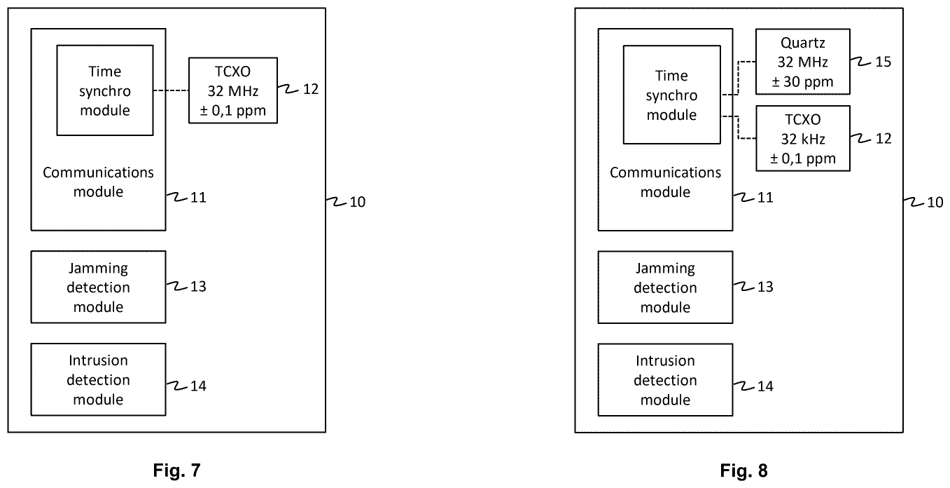

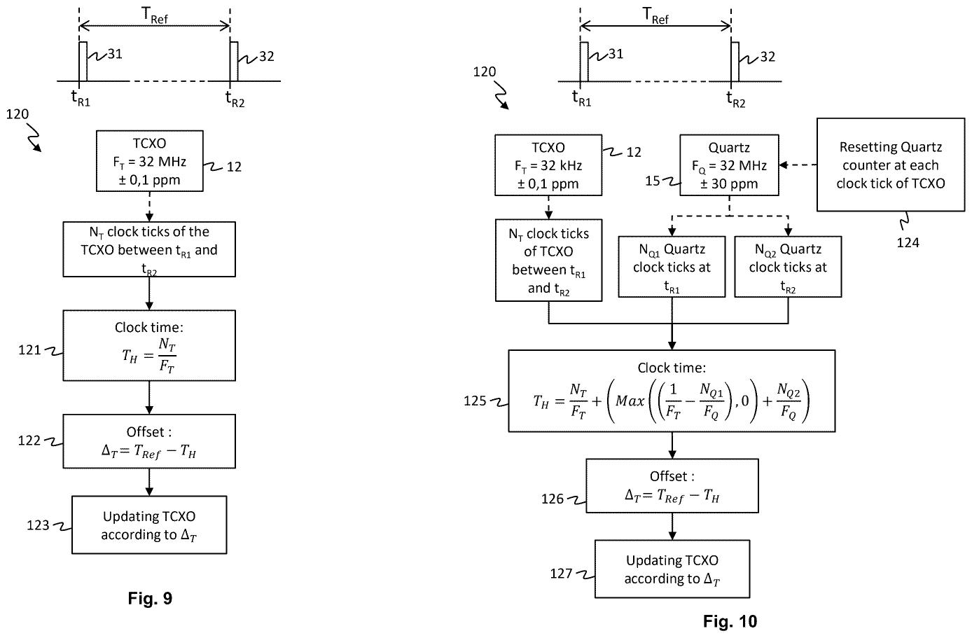

FIGS. 7 and 8 schematically show exemplary embodiments of the alarm device 10 according to the present disclosure. The alarm device 10 particularly comprises a communication module 11, a clock 12, a jamming detection module 13 and an intrusion detection module 14.

The communication module 11 implements the functions allowing the alarm device 10 to communicate with the cellular network 20. In particular, the communication module 11 comprises software and/or hardware means configured to exchange (send and receive) messages with the cellular network 20. These means are considered to be known to those skilled in the art.

The clock 12 is used by the communication module to synchronize temporally and frequentially with a clock of the cellular network 20. Indeed, in order to be able to receive a message from the cellular network 20, or to be able to transmit a message to the cellular network 20, the communication module 11 must be capable of accurately determining the start time of a communication frame. In the case of LTE or 5G-NR, a communication frame lasts ten milliseconds; each frame has ten subframes; each subframe comprises two slots; each slot comprises seven OFDMA symbols (acronym of “Orthogonal Frequency Division Multiple Access”, which consists of a data multiplexing and coding technique). Each OFMA symbol comprises radio samples and a cyclic prefix (CP). The cyclic prefix is used as a guard interval (time margin), in order to maintain the orthogonality and sinusoidal properties of the signal in the case of multiple paths. The first cyclic prefix of a communication frame has a duration of about 5.2 μs (microseconds); the cyclic prefixes preceding the six other symbols have a duration of about 4.7 μs. The time of transmission of a message by the alarm device 10 must generally have a precision less than the duration of a cyclic prefix for the message to be correctly received by the cellular network 20. The clock 12 corresponds for example to a temperature-controlled X (crystal) oscillator (TCXO).

The materials of the crystals and the manufacturing processes of the clock 12 of the alarm device 10 and the clock of the base station 21 to which the alarm device 10 is connected are different and this may cause an offset between the clocks. This frequency shift may also be impacted by environmental factors such as temperature or humidity. As will be seen hereinafter, it is therefore necessary to correct any drift of the clock 12 of the alarm device 10 relative to the clock of the base station 21 (however, the estimation of the frequency offset allowing this correction cannot conventionally be performed in the presence of jamming).

The jamming detection module 13 comprises software and/or hardware means for implementing functions allowing the alarm device 10 to check whether jamming of the frequency bands of the downlink 24 of the cellular network 20 is present or not. The jamming detection module 13 can particularly be interfaced with the communication module 11 and/or reuse sub-modules of the communication module 11. Likewise, there would be nothing to prevent, in one variant, the jamming detection module from being integrated within the communication module 11.

The intrusion detection module 14 comprises software and/or hardware means to detect whether an intrusion has occurred in the zone to be protected. These means are considered to be known to a person skilled in the art. Conventionally, the intrusion detection module 14 may particularly be interfaced with infrared sensors, radar sensors, and/or door or window opening detectors. These sensors may be integrated within the alarm device 10, but they may also correspond to separate physical entities from the alarm device 10. If the sensors are separate physical entities from the alarm device 10, these sensors may communicate with the intrusion detection module 14 using a different wireless communication protocol from that implemented by the cellular network 20, and the communication between the sensors and the intrusion detection module 14 is then not compromised by jamming of the frequencies of the cellular network 20.

The alarm device 10 is configured to implement the steps of the method 100 according to the present disclosure to be able to transmit an alert message even in the presence of jamming. The communication module 11, the clock 12, the jamming detection module 13 and the intrusion detection module 14 represent means configured in a software and/or hardware manner to implement this method 100. The alarm device 10 may in particular comprise one or more processors and storage means (electronic memory) wherein a computer program product is stored, in the form of a set of program code instructions to be executed to implement the different steps of the method 100. The communication module 11, the jamming detection module 13 and the intrusion detection module 14 may be implemented by a single processor, or by several separate processors. Alternatively or in addition, the alarm device 10 may comprise one or more programmable logic circuits (FPGA, PLD, etc.), and/or one or more specialized integrated circuits (ASIC), and/or a set of discrete electronic components adapted to implement the steps of the method 100.

As illustrated by FIGS. 1 and 2, method 100 comprises the following steps:
at a first time t₁, in the absence of jamming: a step of obtaining 110, from a message transmitted by the cellular network 20 and received by the alarm device 10, preconfigured radio resources capable of being used for the transmission of the alert message at least one future transmission time t_{E1},
at least one calibration time t_{C1} between the first time t₁ and the future time t_{E1}: a step of calibrating 120 the clock 12 of the alarm device 10 to correct any drift thereof relative to a clock of the cellular network 20,
when an intrusion is detected by the alarm device 10 (at the intrusion detection time t_{D}): a step of checking 130 whether jamming is present,
if jamming is present: a step of transmitting 140 the alert message at the future time t_{E1} using the preconfigured radio resources.

The preconfigured radio resources are temporal and frequential radio resources for the uplink 23: they define one or more time slots and one or more frequencies to be used for the transmission of a message by the alarm device 10 to the cellular network 20.

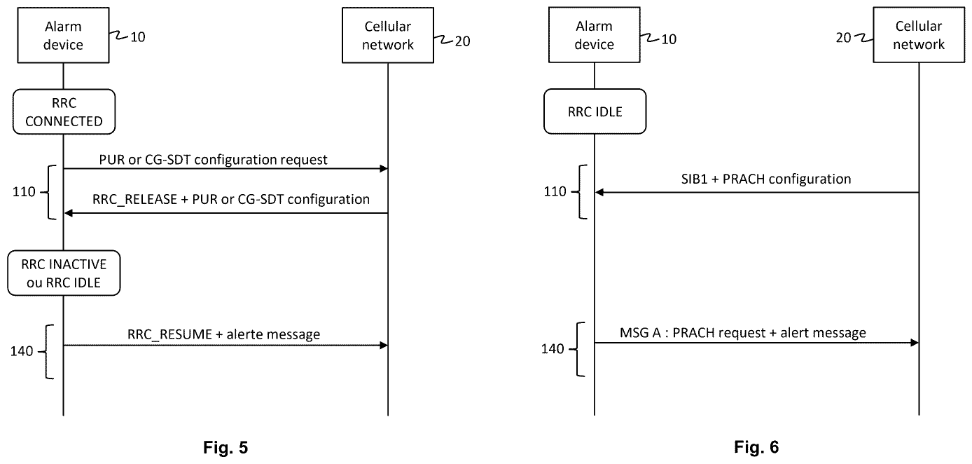

As will be seen hereinafter, they may consist for example of radio resources of a physical uplink shared channel: PUSCH channel (acronym of “Physical Uplink Shared Channel”) in the case of LTE or 5G-NR, or NPUSCH channel (acronym of “Narrow-Band Physical Uplink Shared Channel”) in the specific case of LTE-M or NB-IoT. These preconfigured radio resources can in particular be obtained via “PUR” (acronym of “Preconfigured Uplink Resource”) or “CG-SDT Type 1” (“Configured Grant Small Data Transmission Type 1”) procedures. These procedures will be described in more detail later with reference to FIG. 5. In such a case, the preconfigured radio resources are resources specifically allocated by the cellular network 20 for the alarm device 10 (these radio resources cannot be used by another device).

According to another example, they may consist of radio resources of a packet random access channel (PRACH channel). These preconfigured radio resources correspond for example to a PRACH configuration received by the alarm device 10 in a system information message (SIB1, for “System Information Block #1”) transmitted by the cellular network 20. These radio resources may in particular be used by the alarm device 10 in a two-step short packet transmission procedure on a random access channel (“2-step RA-SDT”, for “Two-step Random Access Small Data Transmission i”). This procedure will be described in more detail later with reference to FIG. 6. In such a case, the preconfigured radio resources are shared resources between several users of the cellular network 20. In other words, these radio resources are not exclusively reserved for the alarm device 10, and consequently there may be collisions between several users (one or more users may use these radio resources at the same time as the alarm device 10).

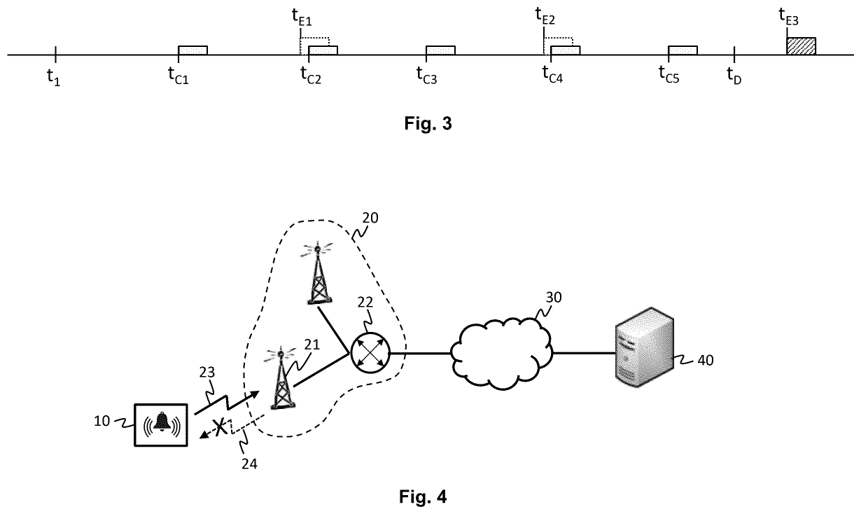

As illustrated in FIG. 3, the preconfigured radio resources may define several transmission opportunities in the future (t_{E1}, t_{E2}, t_{E3}). They may consist of multiple transmission times configured by the PUR procedure or by the CG-SDT procedure, or may consist of several PRACH opportunities.

The temporal distance between the first time t₁ and a future transmission time (for example t_{E1} or t_{E3}) may be greater than a few tens of seconds, for example at least equal to thirty seconds, or even at least equal to one minute. In particular, for the PUR protocol, the temporal distance between the first time t₁ and the first future transmission time corresponds to at least eight hyper-frames (a hyper-frame corresponds to 1024 frames; a hyper-frame therefore has a duration of 10.24 seconds). This therefore corresponds to a temporal distance at least equal to 81.92 seconds.

It is advantageous to obtain preconfigured radio resources offering temporally close transmission opportunities, such that the alert message can be transmitted as quickly as possible when an intrusion is detected.

As illustrated in FIGS. 2 and 3, several calibration times (t_{C1}, t_{C2}, t_{C3}) can be defined, for example with a periodic repetition. As will be seen hereinafter, the calibration times may particularly be defined by the alarm device according to the precision of the clock 12, according to the duration of a cyclic prefix of a frame, and/or according to the future transmission times (t_{E1}, t_{E2}, t_{E3}). The calibration times are defined by the alarm device 10, and they are not specified by the standard implemented by the cellular network 20.

It should be noted that, as illustrated in FIG. 2, steps 110 (obtaining the preconfigured radio resources) and 120 (calibrating the clock 12 of the alarm device 10) can be iterated several times before an intrusion is detected.

In particular, and as illustrated in FIG. 2, the step 115 of determining a next calibration time can be repeated each time a calibration 120 of the clock 12 of the alarm device 10 is performed, as long as there is no intrusion detected. A new calibration 120 of the clock 12 is performed each time a calibration time is reached.

Also, and as illustrated in FIG. 2, the preconfigured radio resources may be valid only for a predetermined duration. When the end of validity of the preconfigured radio resources is reached, the step of obtaining 110 preconfigured radio resources may then be repeated to obtain new preconfigured radio resources. This renewal of the preconfigured radio resources may take place several times (potentially a large number of times) before an intrusion is detected. For example, the preconfigured radio resources may become invalid if a predefined number of successive transmission opportunities are not used. In particular, it is advantageous to periodically repeat the renewal of the preconfigured radio resources so as to permanently retain at least one transmission opportunity of an alert message in the future (i.e. so as to permanently have at least one configured future transmission time).

As illustrated in FIG. 2, in response to the detection of an intrusion, the alarm device 10 performs a check 130 whether frequency jamming of the downlink 24 is present.

In the absence of jamming (i.e. in the case where the checking step 130 indicates that there is no jamming), the alert message may be transmitted conventionally, for example with a four-step random packet access channel procedure (4-step PRACH). This procedure particularly makes it possible to ensure precise synchronization between the alarm device 10 and the cellular network 20 just before the transmission of the alert message. This also makes it possible to transmit the alert message as quickly as possible (no need to reach the future transmission time defined by the preconfigured resources). The conventional four-step random access procedure is described hereinafter with reference to FIG. 11.

On the other hand, if jamming is present (i.e. in the case where the checking step 130 indicates that there is jamming), the alarm device 10 performs a transmission 140 of the alert message at the future time (t_{E1} in the example of FIG. 1, t_{E3} in the example of FIG. 3) using the preconfigured radio resources. In this case, it is important to note that this transmission 140 of the alert message is performed without requiring the reception of a message on the downlink 24 between the jamming detection time and the transmission time of the alert message (reception of such a message is not possible due to jamming). The calibration step(s) 120 performed between the time of obtaining the preconfigured radio resources and the transmission time of the alert message advantageously make it possible to compensate for the lack of precise synchronization between the alarm device 10 and the cellular network 20 just before the transmission of the alert message.

FIG. 5 illustrates the steps of obtaining 110 the preconfigured radio resources and transmitting 140 the alert message when the method 100 is based on the “PUR” procedure or on the CG-SDT Type 1 procedure. The PUR procedure is defined by the 3GPP R16 (Release 16) specification. The CG-SDT Type 1 procedure is defined by the 3GPP R17 (Release 17) specification.

As illustrated in FIG. 5, when the alarm device 10 is in connected mode (“RRC_CONNECTED” mode), a PUR configuration or a CG-SDT configuration may be obtained in an “RRC Release” message (connection release message) transmitted by the base station 21 of the cellular network 20 to which the alarm device 10 is connected (in response to a request previously transmitted by the alarm device 10). The alarm device 10 then switches to idle mode (“RRC_IDLE” mode) in the PUR case, or to inactive mode (“RRC_INACTIVE” mode) in the CG-SDT case. The alarm device 10 then has the possibility of transmitting an alert message at each transmission opportunity defined by the PUR or CG-SDT configuration. The alert message is included in a connection resumption message (“RRC Resume” message) transmitted on the uplink shared channel (“PUSCH” channel or “NPUSCH” channel).

In the case of PUR, the request message to request a PUR configuration is described in 3GPP specification 36.331 v16.0.0 in section 5.6.23.2. In particular, the alarm device 10 has the possibility of defining the number and the period of repetition of the sought PUR transmission opportunities. The PUR configuration is defined in section 6.3.2 (or in section 6.7.3.2 for the IoT case).

The CG-SDT procedure is described for example in section 8.20.2 of 3GPP specification 38.401 v17.0.0, or in section 5.27 of 3GPP specification 38.321 v17.0.0. The CG-SDT configuration is defined in section 6.3.2 of the 3GPP specification 38.331 v17.0.0. It particularly defines the number and period of repetition of CG-SDT transmission opportunities.

The 3GPP standard describes the conditions to be fulfilled in relation to the validation of a timing advance (TA) between the terminal and the base station 21. This validation is particularly based on a condition relative to a power level received from a reference signal (RSRP for “Reference Signal Receive Power”, or NRSRP for “Narrow-Band Reference Signal Receive Power”) for the base station 21. For the PUR procedure, these conditions are described in particular in section 5.3.3.1 of the 3GPP 36.331 v16.0.0 specification. For the CG-SDT procedure, they are described in section 5.27.2 of the 3GPP 38.321 v17.0.0 specification.

Contrary to what is recommended by the standard, in the method 100 according to the present disclosure, the alert message is transmitted by the alarm device 10 independently of a condition relative to the power level received from a reference signal (RSRP, or NRSRP), or to a timing advance (TA), for the base station 21. Indeed, in the presence of jamming, the reference signal will be masked by the jamming, and the power level received from the reference signal will not be relevant and will not make it possible to validate the timing advance. It is therefore necessary, in the event of jamming, to disregard the power level received from the reference signal, and to consider that the timing advance is always valid. This consists of a deviation from the specification.

It should be noted that the CG-SDT Type 2 procedure conditions the transmission of a message to the prior reception of a control message on the downlink 24 (DCI message, acronym of “Downlink Control Indication”). However, in the event of jamming, it will not be possible to receive this DCI message on the downlink 24. Therefore, the CG-SDT Type 2 procedure cannot be used in the event of jamming.

FIG. 6 illustrates the steps of obtaining 110 the preconfigured radio resources and transmitting 140 the alert message when the method 100 is based on the “2-step RA-SDT” two-step short packet transmission procedure on a random access channel. This procedure is defined by the 3GPP R17 (Release 17) specification.

In the example illustrated in FIG. 6, when the alarm device 10 is in idle mode (“RRC_IDLE” mode), a PRACH configuration may be obtained in a SIB1 message transmitted by the base station 21 of the cellular network 20 to which the alarm device 10 is attached (the SIB1 message is transmitted periodically by the base station 21). The alert message may then be transmitted by the alarm device 10 on a random access channel (PRACH channel, or NPRACH channel in the case of IoT) using the radio resources defined in the PRACH configuration.

The PRACH configuration is defined in the 3GPP 36.331 v16.0.0 specification in section 6.3.2. It particularly defines the number of PRACH opportunities available, when to transmit, and which frequencies to use.

The conventional 4-step PRACH procedure is described in FIG. 11. In the four-step PRACH procedure, a terminal (UE for “User Equipment”) performs a contention resolution to transmit data. For this purpose, in a first step, the terminal transmits a random access request message (“Msg1”, “PRACH request”). In a second step, the access network responds to this request by transmitting a response message (“Msg2”, “PRACH response”) allocating to the terminal radio resources that can be used by its data transmission. The terminal may then transmit its data, during a third step, in a data transmission message (“Msg3”, “Data transmission”) on the PUSCH channel. In a fourth and final step, the network transmits a message confirming the contention resolution (“Msg 4”, “Contention resolution”).

In the event of frequency jamming of the downlink, the terminal cannot receive messages from the cellular network. The conventional four-step PRACH procedure is therefore not possible.

In the “2-step RA-SDT” two-step procedure, and as illustrated in FIG. 6, the terminal transmits its data directly in the first message, “Msg A”, at the same time as the PRACH Request. Thus, after receiving the PRACH configuration in a SIB1 message, the terminal no longer needs to receive another message from the cellular network on the downlink in order to be able to transmit its data. The message “Msg A” corresponds to the combination of the messages “Msg 1” and “Msg 3” of the conventional four-step procedure. The cellular network then transmits a response message “Msg B” which corresponds to the combination of “Msg 2” and “Msg 4” of the conventional four-step procedure (this message “Msg B” is not shown in FIG. 6 because it is not received by the alarm device 10 in the event of jamming).

The 3GPP standard describes conditions to be fulfilled relative to the received power level of the reference signal (RSRP, or NRSRP). In particular, the 3GPP standard recommends that the two-step random access procedure can only be used if the power level received from the reference signal is above a predefined threshold. Contrary to what is recommended by the standard, in the method 100 according to the present disclosure, the alert message is transmitted by the alarm device 10 independently of a condition relating to the power level received from the reference signal for the base station 21. Indeed, in the presence of jamming, the reference signal will be masked by the jamming, and the power level received from the reference signal is irrelevant.

It is possible that the message “Msg A” containing the alert message is not correctly received by the cellular network 20 because, as explained above, the PRACH radio resources are not exclusively reserved for the alarm device 10 (there may be collisions with one or more other users who may use these radio resources at the same time as the alarm device 10). To optimize the chances of the alert message being correctly received by the cellular network 20 (then routed to the remote monitoring server 40), it is advantageous to repeat the alert message several times, at several PRACH transmission opportunities (several future transmission times). For example, the message “Msg A” containing the alert message is repeated four times, at four different PRACH opportunities.

It should be noted that the 3GPP standard introduced the PUR, CG-SDT, and RA-SDT procedures to limit energy consumption of terminals and to optimize the use of radio resources. The 3GPP standard does not recommend the use of these procedures to overcome the presence of frequency jamming of the downlink. The use of these procedures to allow a terminal to transmit even in the presence of frequency jamming is therefore particularly unexpected.

The step of checking 130 whether jamming is present may in particular comprise partitioning at least one frequency band of the downlink 24 of the cellular network 20 into several frequency sub-bands, and measuring, for each frequency sub-band, a received radio power level (RSSI for “Received Signal Strength Indication”). A jamming detection criterion can then be evaluated according to the measurements obtained. For example, the jamming detection criterion is fulfilled if the RSSI of at least one sub-band is greater than a threshold, or if the average of the RSSIs of the different sub-bands is greater than a threshold.

The width of a frequency band of the downlink 24 of the cellular network 20 may indeed correspond to several tens of megahertz, for example 30 MHz, and it is advantageous to partition it into narrower sub-bands, for example 1 MHz sub-bands, or even 180 kHz sub-bands, in order to obtain individual RSSIs representative of the different sub-bands. If only a few sub-bands have an abnormally high power level, it is possible that this is simply due to a network overload. On the other hand, if a very large proportion of the sub-bands have an abnormally high power level, it is likely that this is due to jamming.

FIG. 7 shows a first exemplary embodiment of an alarm device 10 according to the present disclosure, wherein the clock 12 is a 32 MHz TCXO having a precision of 0.1 parts per million (ppm). This means that, in unfavorable situations, the clock drift may cause an additional time error of 0.1 μs per second. It has been seen above that, in the case of PUR, the temporal distance between the time t₁ of obtaining the preconfigured radio resources and the first future transmission time t_{E1} is at least 81.92 seconds, which corresponds in the worst case to a time error of about 8.2 μs due to clock drift. This error being greater than the duration of the cyclic prefix of an OFDMA slot, it could lead to the cellular network 20 being unable to correctly decode a message transmitted by the alarm device 10. For this reason, one or more calibration steps 120 must be carried out between the time t₁ of obtaining the preconfigured radio resources and the transmission time tri of the alert message, in order to maintain precise synchronization between the alarm device 10 and the cellular network 20 (or in other words to correct the drift of the clock 12).

In particular, it is possible to define a maximum authorized drift duration according to the duration of a cyclic prefix and according to the level of precision of the clock 12. This maximum duration corresponds, for example, to the time after which the time error due to the drift will become greater than the duration of a cyclic prefix if placed in the worst case. In the example considered, the maximum drift duration would be about 47 seconds if it is sought to ensure having a time error less than 4.7 μs. This means that a new calibration 120 of the clock 12 must be performed at least every 47 seconds. It may, for example be envisaged to perform a new calibration 120 every 40 seconds.

As illustrated in FIGS. 1 and 9, the calibration step 120 may comprise:
computing 121 a clock time T_{H} corresponding to a number N_{T} of clock ticks performed by the clock 12 of the alarm device 10 between a reception time tri of a first synchronization frame 31, and a reception time t_{R2} of a second synchronization frame 32,
computing 122 an offset Δ_{T} corresponding to a time difference between the clock time T_{H} and a reference time T_{Ref} corresponding to a theoretical time difference separating the first and second synchronization frames,
updating 123 the clock 12 of the alarm device 10 according to the offset thus computed.

The synchronization frames may particularly correspond to primary synchronization signal (PSS for “Primary Synchronization Signal”, or NPSS for “Narrow-Band Primary Synchronization Signal” in the case of IoT) frames.

For example, and as illustrated in FIG. 1, the first (N)PSS frame 31 is received prior to the calibration time t_{C1} (for example at a time close to the time t₁ of obtaining the preconfigured radio resources, or at a previous calibration time). The second (N)PSS frame 32 is received at a time close to the calibration time t_{C1} (it consists for example of the first (N)PSS frame received after t_{C1}).

The reference time T_{Ref} corresponds to the system frame number (SFN) separating the two synchronization frames multiplied by the duration of a frame. The clock time T_{H} is equal to the number N_{T} of clock ticks multiplied by the duration of a clock tick. The duration of a clock tick is equal to the inverse of the TCXO frequency F_{T}. The offset Δ_{T} corresponds to a difference between T_{Ref} and T_{H}.

In step 123, to compensate for the drift, the pitch of the TXCO phase-locked loop (PLL) may then be modified according to the offset Δ_{T} computed.

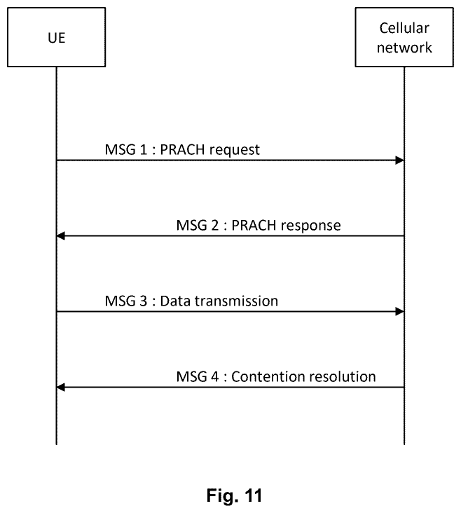

However, a high-precision and high-frequency clock (such as that of the first embodiment described with reference to FIGS. 7 and 9) is expensive and energy-consuming. For this reason, a second embodiment is proposed and described with reference to FIGS. 8 and 10.

In this second embodiment, and as illustrated in FIG. 8, the clock 12 is a 32 kHz TCXO having a precision of 0.1 ppm (in other words, it consists of a high-precision and low-frequency clock). The alarm device 10 further comprises a 32 MHz clock 15 with a precision of 30 ppm (in other words, it consists of an additional low-precision and high-frequency clock).

It should be noted that the frequency and precision features given here for the clocks 12 and 15 of the alarm device 10 are in no way limiting. Other values could be envisaged. In particular, the terms “high-precision” and “low-precision” are to be considered relative to each other. This means in particular that the precision of the high-precision clock is greater than that of the low-precision clock (for example the precision of the high-precision clock is at least 10 times, or even at least 50 times, or even at least 100 times, greater than that of the low-precision clock). The same applies for the terms “high-frequency” and “low-frequency” (for example, the frequency of the high-frequency clock is at least 100 times, or even at least 500 times, or even at least 1000 times greater than that of the low-frequency clock).

As illustrated in FIG. 10, the calibration step 120 may then comprise:
at each clock tick of the low-frequency clock 12, resetting 124 a clock tick counter of the high-frequency clock 15,
determining 125 a number N_{T} of clock ticks of the low-frequency clock 12 between a reception time tri of a first synchronization frame 31, and a reception time t_{R2} of a second synchronization frame 32,
computing 125 a clock time T_{H} according to the number N_{T} of clock ticks of the low-frequency clock 12, and according to the numbers N_{Q1} and N_{Q2} of clock ticks indicated by the clock tick counter of the high-frequency clock 15 respectively at the reception time t_{R1} of the first synchronization frame 31 and at the reception time t_{R2} of the second synchronization frame 32,
computing 126 an offset Δ_{T} corresponding to a difference between the clock time T_{H}, and the reference time T_{Ref} corresponding to the theoretical time difference separating the first and second synchronization frames,
updating 127 the low-frequency clock 12 according to the offset thus computed.

The clock time T_{H} corresponds to the number of complete cycles of the low-frequency clock 12 performed between t_{R1} and t_{R2} to which the incomplete clock cycle ended after t_{R1} and the incomplete clock cycle started before t_{R2} should be added.

The duration of the incomplete clock cycle ended after t_{R1} is computed according to the number N_{Q1} of clock ticks indicated by the clock tick counter of the high-frequency clock 15 at the time t_{R1}. It can be computed in the form

$$Max ( ( \frac{1}{{F}_{T}} - \frac{{N}_{Q 1}}{{F}_{Q}} ) , 0 ) ,$$

an expression wherein F_{Q} is the frequency of the high-frequency clock 15.

The duration of the incomplete clock cycle started before t_{R2} is computed according to the number N_{Q2} of clock ticks indicated by the clock tick counter of the high-frequency clock 15 at the time t_{R2}. It is equal to

$$\frac{{N}_{Q 2}}{{F}_{Q}} .$$

Advantageously, even if the precision of the high-frequency clock 15 is low (30 ppm in the example considered), the time error due to the cumulative drift over a clock cycle of the low-frequency clock 12 remains low. The second embodiment described with reference to FIGS. 8 and 10 thus makes it possible to maintain precise synchronization between the alarm device 10 and the cellular network 20 without having to use a high-precision high-frequency clock. This second embodiment is particularly advantageous for alarm devices operating with batteries or a battery.

It should be noted that it can also be envisaged to calibrate the high-frequency clock 15 at each clock tick of the low-frequency clock 12, or each time a predetermined number of clock ticks of the low-frequency clock 12 is reached, in order to limit the drift of the high-frequency clock 15.

What is claimed is:

1. A method for transmitting an alert message by an alarm device, to a cellular network, in the presence of jamming of frequency bands of a downlink of the cellular network, said method comprising the following steps:
at a first time, in the absence of jamming: obtaining, from a message transmitted by the cellular network and received by the alarm device, preconfigured radio resources intended to be used for the transmission of the alert message at least one future time,
at least one calibration time between the first time and said at least one future time: calibrating a clock of the alarm device to correct any drift of said clock relative to a clock of the cellular network,
when an intrusion is detected by the alarm device: checking whether jamming is present,
if jamming is present: transmitting the alert message at said at least one future time using the preconfigured radio resources.

2. The method according to claim 1, wherein:
the cellular network is an LTE or 5G-NR network supporting the “PUR” procedure defined by the 3GPP R16 specification,
the preconfigured radio resources are defined by a “PUR” configuration received by the alarm device in a connection release message, “RRC Release”, transmitted by a station of the cellular network,
the alert message is transmitted by the alarm device on an uplink shared channel, “(N)PUSCH”, independently of a condition relative to the power level received from a reference signal, “(N)RSRP”, or to a timing advance, “TA”, for said station.

3. The method according to claim 1, wherein:
the cellular network is a 5G-NR network supporting the “CG-SDT Type 1” procedure defined by the 3GPP R17 specification,
the preconfigured radio resources are defined by a “CG-SDT Type 1” configuration received by the alarm device in a connection release message, “RRC Release”, transmitted by a station of the cellular network,
the alert message is transmitted by the alarm device on an uplink shared channel, “(N)PUSCH”, independently of a condition relative to the power level received from a reference signal, “(N)RSRP”, or to a timing advance, “TA”, for said station.

4. The method according to claim 1, wherein:
the cellular network is a 5G-NR network supporting the two-step short packet transmission procedure on a random access channel, “2-step RA-SDT”, defined by the 3GPP R17 specification,
the preconfigured radio resources are defined by a “PRACH” configuration received by the alarm device in a system information message, “SIB1”, transmitted by a station of the cellular network,
the alert message is transmitted by the alarm device on a random access channel, “(N)PRACH”, independently of a condition relative to the power level received from a reference signal, “(N)RSRP”, for said station.

5. The method according to claim 4, wherein the preconfigured radio resources define several transmission opportunities at several future times, and the alert message is repeatedly transmitted at several of said future times.

6. The method according to claim 1, wherein the calibration step comprises:
computing a clock time corresponding to a number of clock ticks performed by the clock of the alarm device between a reception time of a first synchronization frame, and a reception time of a second synchronization frame,
computing an offset corresponding to a time difference between the clock time and a reference time (T_{Ref}) corresponding to a theoretical time difference separating the first and second synchronization frames,
updating the clock of the alarm device according to the offset thus computed.

7. The method according to claim 1, wherein the clock of the alarm device is a high-precision and low-frequency clock, the alarm device further comprises an additional low-precision and high-frequency clock, and the calibration step comprises:
at each clock tick of the low-frequency clock, resetting a clock tick counter of the high-frequency clock,
determining a number of clock ticks of the low-frequency clock between a reception time of a first synchronization frame, and a reception time of a second synchronization frame,
computing a clock time according to the number of clock ticks of the low-frequency clock, and according to the number of clock ticks indicated by the clock tick counter of the high-frequency clock respectively at the reception time of the first synchronization frame and at the reception time of the second synchronization frame,
computing an offset corresponding to a difference between the clock time thus computed, and a reference time (T_{Ref}) corresponding to a theoretical time difference separating the first and second synchronization frames,
updating the low-frequency clock according to the offset thus computed.

8. The method according to claim 1, wherein said at least one calibration time is defined by the alarm device according to a maximum drift duration, said maximum drift duration being predefined according to the duration of a cyclic prefix present in a frame of the cellular network and according to a precision level of the clock of the alarm device.

9. The method according to claim 1, wherein the step of checking whether jamming is present comprises:
partitioning at least one frequency band of the downlink of the cellular network into several frequency sub-bands,
measuring, for each frequency sub-band, of a received radio power level,
evaluating a jamming detection criterion according to the measurements obtained.

10. An alarm device, adapted to transmit an alert message to a cellular network in the presence of jamming of frequency bands of a downlink of the cellular network, said alarm device comprising:
a wireless communication module adapted to communicate with the cellular network,
a clock,
a jamming detection module, and
an intrusion detection module,
the alarm device is configured to:
at a first time, in the absence of jamming: obtain preconfigured radio resources, from a message transmitted by the cellular network and received by the communication module, said preconfigured radio resources being intended to be used by the communication module to transmit the alert message at least one future time,
at least one calibration time between the first time and said at least one future time: calibrate the clock to correct any drift of said clock relative to a clock of the cellular network,
when an intrusion is detected by the intrusion detection module: check whether jamming is present using the jamming detection module,
if jamming is present: transmit the alert message to said least one future time using the preconfigured radio resources.

11. The alarm device according to claim 10, wherein:
the communication module is configured to receive the preconfigured radio resources in a “PUR” configuration included in a connection release message, “RRC Release”, transmitted by a station of the cellular network,
the communication module is configured to transmit the alert message on an uplink shared channel, “(N)PUSCH”, independently of a condition relative to the power level received from a reference signal, “(N)RSRP”, or to a timing advance, “TA”, for said station.

12. The alarm device according to claim 10, wherein:
the communication module is configured to receive the preconfigured radio resources in a “CG-SDT Type 1” configuration included in a connection release message, “RRC Release”, transmitted by a station of the cellular network,
the communication module is configured to transmit the alert message on an uplink shared channel, “(N)PUSCH”, independently of a condition relative to the power level received from a reference signal, “(N)RSRP”, or to a timing advance, “TA”, for said station.

13. The alarm device according to claim 10, wherein:
the communication module is configured to receive the preconfigured radio resources in a “PRACH” configuration included in a system information message, “SIB1”, transmitted by a station of the cellular network,
the communication module is configured to transmit the alert message on a random access channel, “(N)PRACH”, independently of a condition relative to the power level received from a reference signal, “(N)RSRP”, for said station.

14. The alarm device according to claim 10, wherein the alarm device is configured to:
compute a clock time corresponding to a number of clock ticks performed by the clock between a reception time of a first synchronization frame, and a reception time of a second synchronization frame,
compute an offset corresponding to a difference between the clock time and a reference time (t_{Ref}) corresponding to a theoretical time difference separating the first and second synchronization frames,
update the clock according to the offset thus computed.

15. The alarm device according to claim 10, wherein the clock of the alarm device is a high-precision and low-frequency clock, the alarm device further comprises an additional low-precision and high-frequency clock, and the alarm device is configured to:
at each clock tick of the low-frequency clock, reset a clock tick counter of the high-frequency clock,
determine a number of clock ticks of the low-frequency clock between a reception time of a first synchronization frame, and a reception time of a second synchronization frame,
compute a clock time according to the number of clock ticks of the low-frequency clock, and according to the number of clock ticks indicated by the clock tick counter of the high-frequency clock respectively at the reception time of the first synchronization frame and at the reception time of the second synchronization frame,
compute an offset corresponding to a difference between the clock time and a reference time (t_{Ref}) corresponding to a theoretical time difference separating the first and second synchronization frames,
update the low-frequency clock according to the offset thus computed.
